(19) United States
(12) Patent Application Publication
(10) Pub. No.: US 2004/0190745 A1
(43) Pub. Date: Sep. 30, 2004

(54) Adjustable earpiece

(76) Inventor: I Tao Chen, Chong Ho City (TW)

Correspondence Address: I Tao CHEN, P.O. Box 10-69, Chong Ho, Taipei, 235, TW

(21) Appl. No.: 10/404,592

(22) Filed: Mar. 29, 2003

(51) Int. Cl. H04R 25/00

(52) U.S. Cl. 381/381; 381/370; 381/379

(57) ABSTRACT

An adjustable earpiece includes an aperture formed in a housing, and a speaker attached to the housing. An arm includes one end having a projection rotatably engaged into the housing, and having a cavity. An arc includes one end rotatably secured to the other end of the arm and rotatable relative to the arm. A retainer is secured in the housing with such as a lock pin, and includes a catch engaged through the aperture of the housing, and engaged into the cavity of the arm, to rotatably secure the arm to the housing. The arm includes a ball rotatably secured in the housing.

### BACKGROUND OF THE INVENTION

1. Field of the Invention

The present invention relates to an adjustable earpiece, and more particularly to an adjustable wireless earpiece for being easily adjusted to various or suitable angular directions, and for easily and comfortably attaching onto ears of users.

2. Description of the Prior Art

Typical earpieces are provided for attaching onto ears of users, and comprise a hanger member for engaging onto or for attaching onto the ears of the users.

However, the hanger members of the typical earpieces may not be adjusted to various or different angular directions, and thus may not be used to suitably attached onto the ears of the users.

The present invention has arisen to mitigate and/or obviate the afore-described disadvantages of the conventional earpieces.

### SUMMARY OF THE INVENTION

The primary objective of the present invention is to provide an adjustable earpiece for being easily adjusted to various or suitable angular directions, and for easily and comfortably attaching onto ears of users.

In accordance with one aspect of the invention, there is provided an adjustable earpiece comprising a housing including a front portion and a rear portion, and including an aperture formed therein, a cover attached onto the front portion of the housing, a speaker attached to the housing, an arm including a first end having a projection extended therefrom and rotatably engaged into the housing, and having a cavity formed therein, the arm including a second end, an arc including a first end rotatably secured to the second end of the arm, and rotatable relative to the arm, and a retainer secured in the housing, and including a catch extended therefrom and engaged through the aperture of the housing, and engaged into the cavity of the arm, to rotatably secure the first end of the arm to the housing.

The housing includes a recess formed in the rear portion thereof, to rotatably receive the first end of the arm. The first end of the arm includes a ball provided therein, and having the projection extended from the ball, and having the cavity formed in the ball.

The arc includes at least one peripheral groove formed in the first end thereof, and the arm includes at least one peripheral swelling extended therefrom and engaged into the peripheral groove of the arc, to rotatably secure the arm to the arc.

The cover includes at least one orifice formed therein, the housing further includes a circuit board disposed in the housing, and having at least one button disposed thereon and extended through the orifice of the cover.

The housing includes a lock pin extended therefrom, the retainer includes an orifice formed therein to receive the lock pin of the housing, and to position and to solidly retain the retainer within the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an adjustable earpiece in accordance with the present invention;

FIG. 2 is a front perspective view of the adjustable earpiece;

FIG. 3 is a rear perspective view of the adjustable earpiece;

FIG. 4 is a partial side view of the adjustable earpiece, in which a portion of the adjustable earpiece has been cut off to show the inner structure of the adjustable earpiece;

FIG. 5 is a side view of the adjustable earpiece;

FIG. 6 is a front view of the adjustable earpiece;

FIG. 7 is a cross sectional view taken along lines 7-7 of FIG. 6;

FIG. 8 is a rear view of the adjustable earpiece;

FIG. 9 is a rear view similar to FIG. 8, illustrating the operation of the adjustable earpiece; and

FIGS. 10, 11, 12, 13 are perspective views illustrating the operation of the adjustable earpiece.

### DETAILED DESCRIPTION OF THE PREFERRED EMBODIMENT

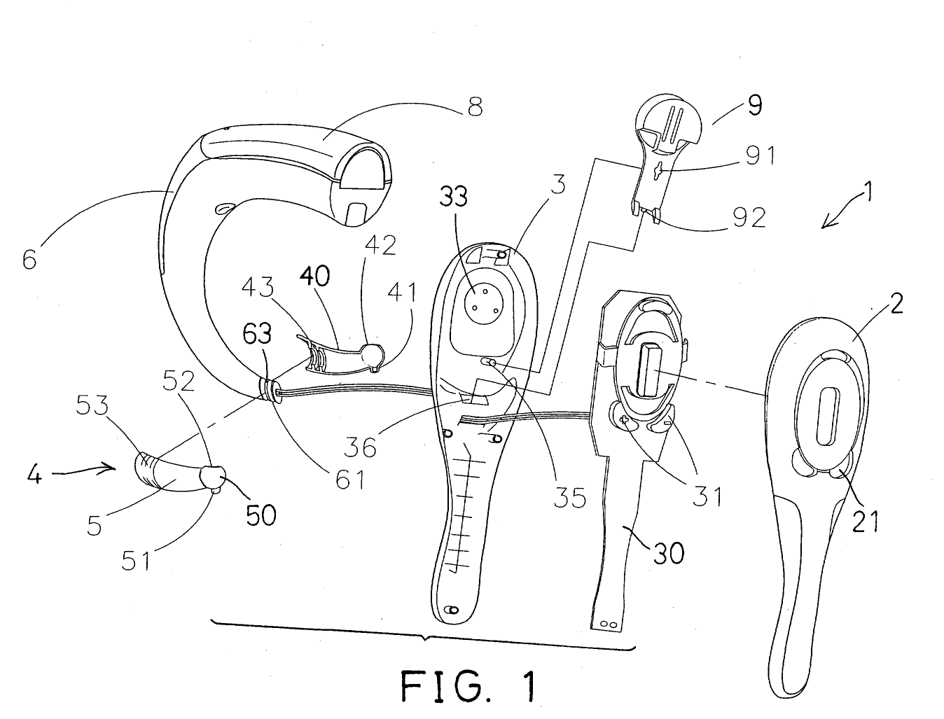

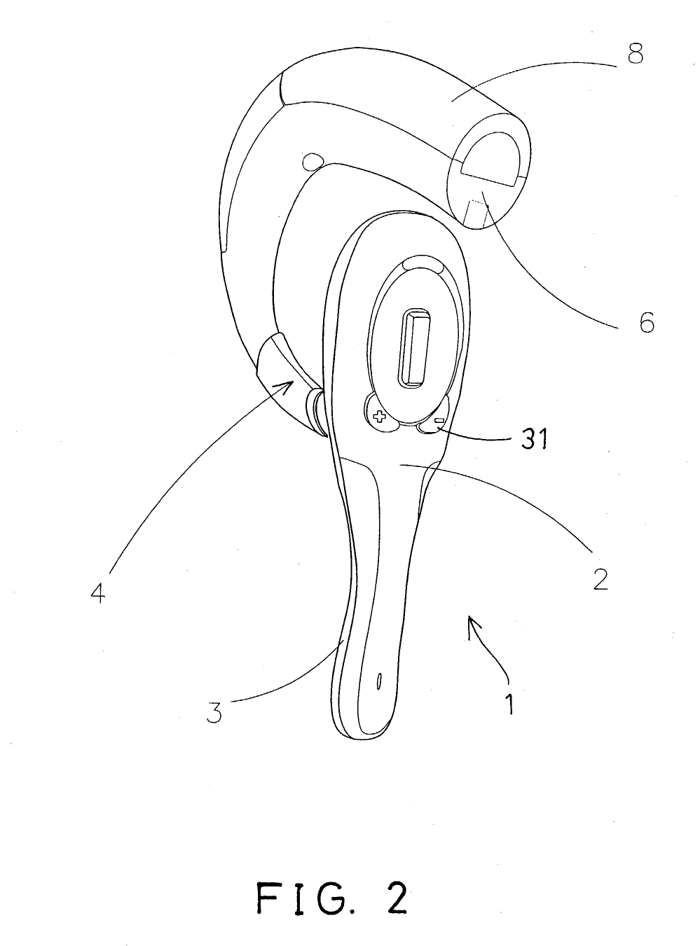

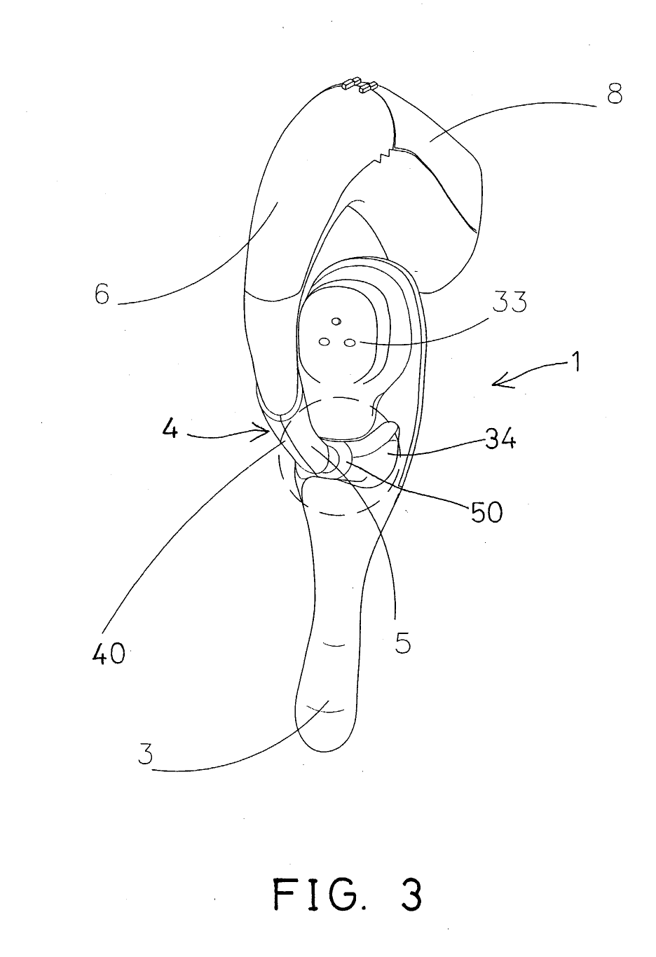

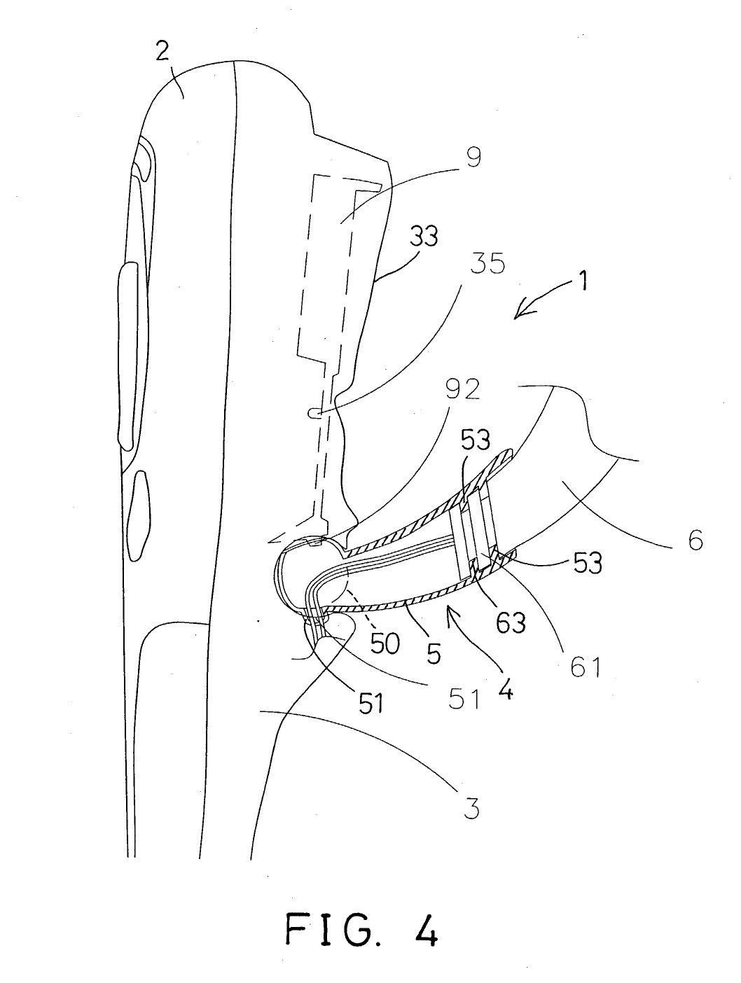

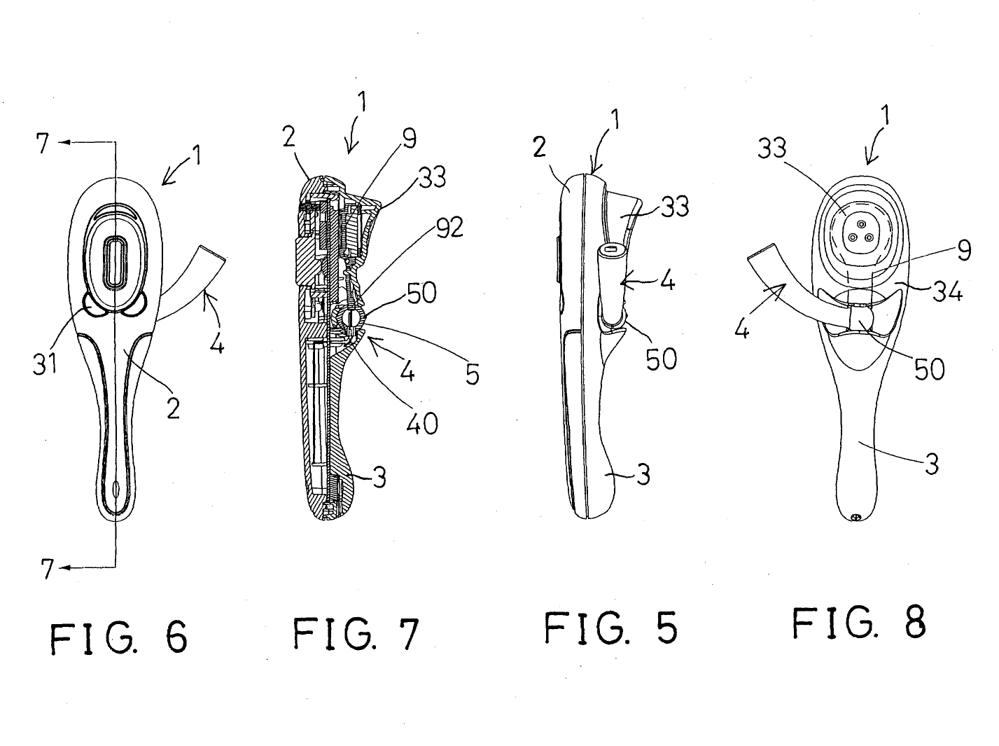

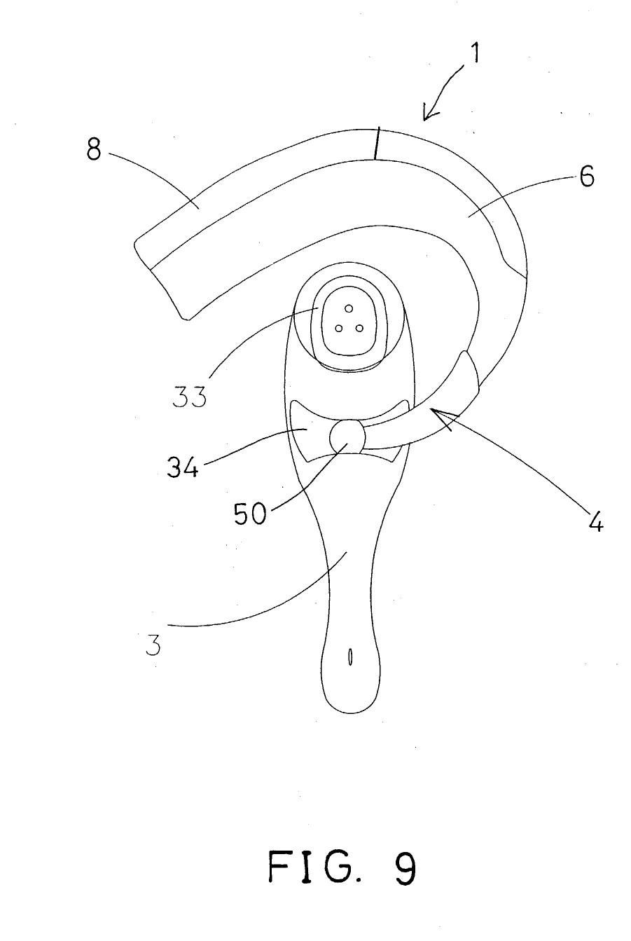

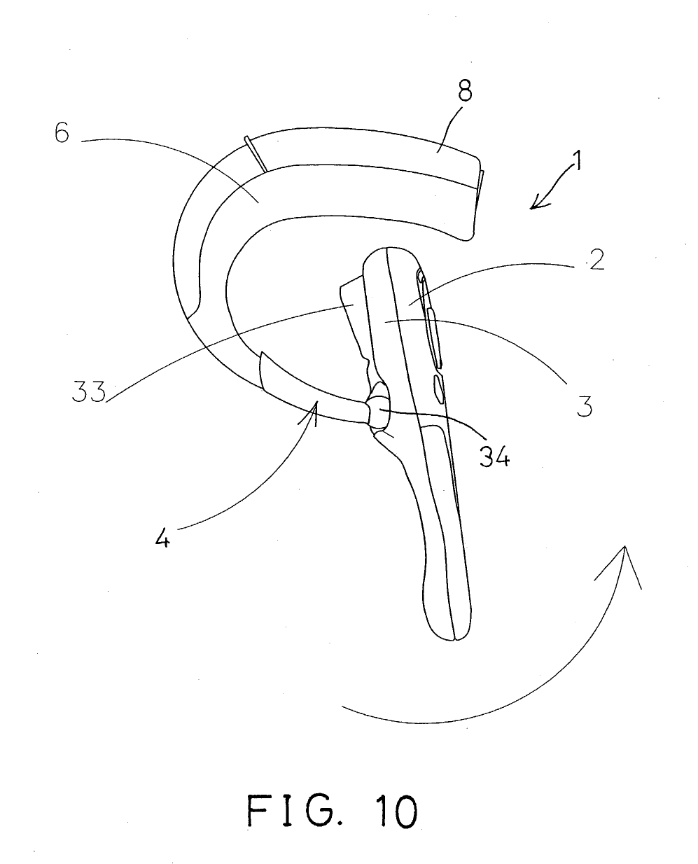

Referring to the drawings, and initially to FIGS. 1-8, an adjustable earpiece 1 in accordance with the present invention comprises a housing 3, and a cover 2 attached and secured onto the housing 3 with such as fasteners (not shown) or the like.

A circuit board 30 is disposed in the housing 3, and includes one or more switches or buttons 31 provided thereon and extended outwardly through one or more corresponding orifices 21 of the cover 2, for controlling the circuit board 30 of the adjustable earpiece 1.

The housing 3 includes a lock pin 35 extended or provided therein, and includes a recess 34 formed in the rear portion thereof, and an aperture 36 formed therein (FIG. 1) and communicating with the recess 34 thereof. A speaker 33 may be attached to the upper portion of the housing 3, and a microphone (not shown) may be attached to the lower portion of the housing 3.

An arm 4 includes such as two pieces or two halves 40, 5 secured together by such as welding processes, or with fasteners, adhesive materials, or the like, and includes a ball 50 provided on one end thereof, and engaged into the recess 34 of the housing 3. The halves 40, 5 of the arm 4 may each include a projection 41, 51 extended therefrom and rotatably engaged into the housing 3, and may each include a cavity 42, 52 formed therein.

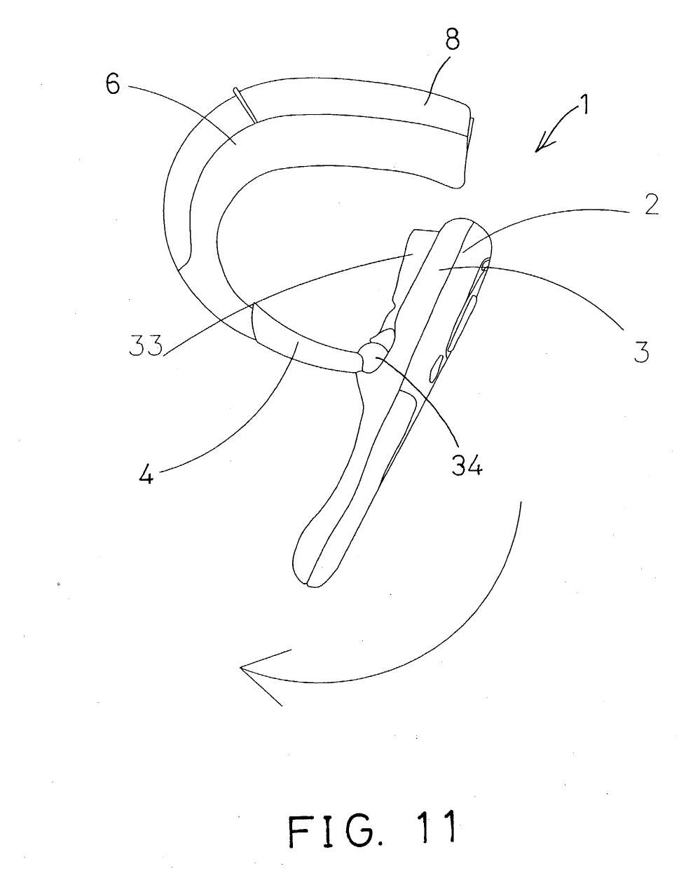

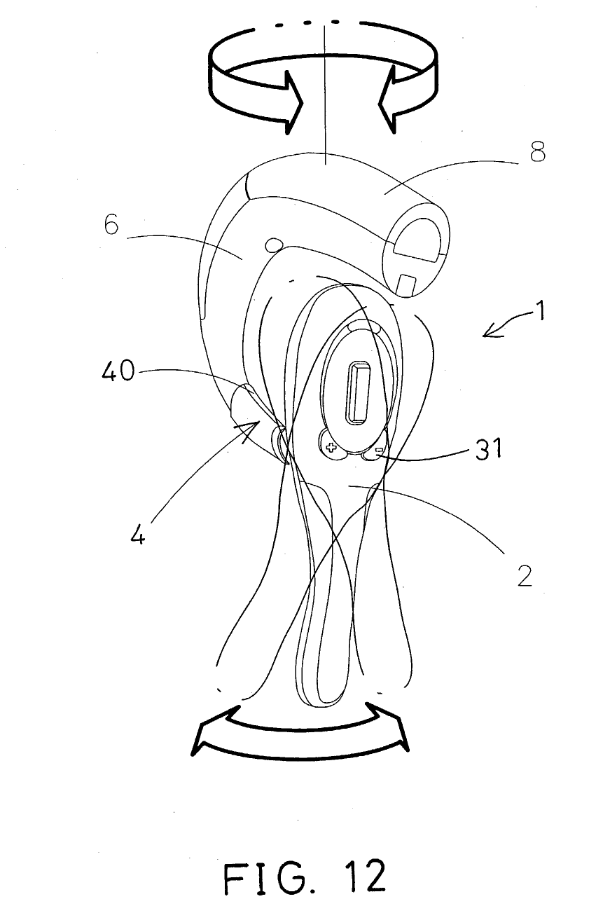

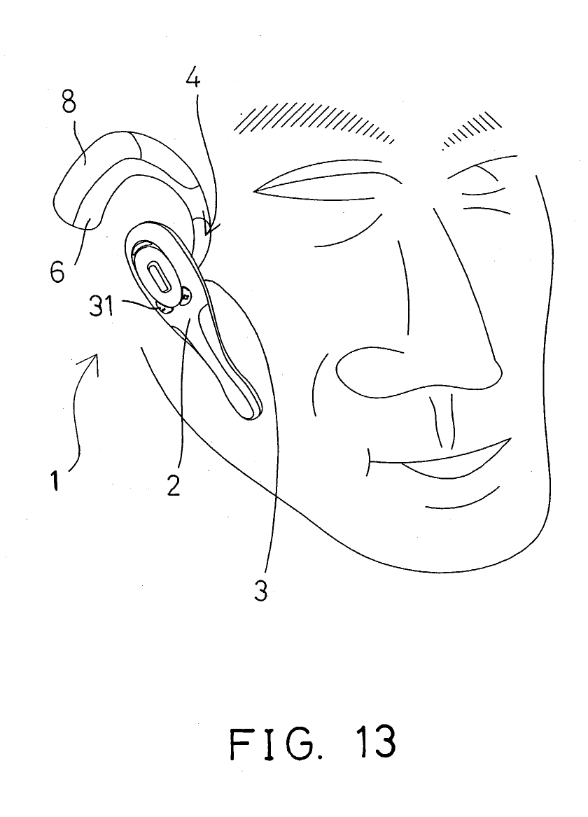

A retainer 9 is received in the housing 3, and preferably secured or retained between the housing 3 and the circuit board 30 or the cover 2, and includes an orifice 91 formed therein to receive the lock pin 35 of the housing 3, and thus to position the retainer 9 within the housing 3. The retainer 9 includes a catch 92 extended therefrom and engaged through the aperture 36 of the housing 3, and engaged into the cavities 42, 52 of the arm 4, to rotatably secure the ball 50 of the arm 4 to the housing 3, and for allowing the arm 4 to be rotated relative to the housing 3, about the projections 41, 51 and the catch 92 (FIGS. 8-12).

An arc 6 includes one or more peripheral bulges 61 and/or one or more peripheral grooves 63 formed in one end thereof and defined between the bulges 61. The one end of the arc 6 may be engaged into the arm 4. The arm includes one or more peripheral swellings 43, 53 engaged into the peripheral grooves 63 of the arc 6, to rotatably secure the arc 6 to the arm 4 (FIG. 12). One or more batteries (not shown) may be received in the arc 6, and enclosed or retained in the arc 6 with a cap 8.

In operation, the arm 4 and thus the arc 6 may be rotated relative to the housing 3, about the projections 41, 51 and the catch 92, and the arc 6 may be rotated relative to the arm 4, such that the arc 6 may be easily adjusted to various or suitable angular directions relative to the arm 4 and the housing 3, and for allowing the adjustable earpiece to be easily and comfortably attaching onto ears of users.

Accordingly, the adjustable earpiece in accordance with the present invention may be used and provided for being easily adjusted to various or suitable angular directions, and for easily and comfortably attaching onto ears of users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adjustable earpiece comprising:
a housing including a front portion and a rear portion, and including an aperture formed therein,
a cover attached onto said front portion of said housing,
a speaker attached to said housing,
an arm including a first end having a projection extended therefrom and rotatably engaged into said housing, and having a cavity formed therein, said arm including a second end,
an arc including a first end rotatably secured to said second end of said arm, and rotatable relative to said arm, and
a retainer secured in said housing, and including a catch extended therefrom and engaged through said aperture of said housing, and engaged into said cavity of said arm, to rotatably secure said first end of said arm to said housing.

2. The adjustable earpiece as claimed in claim 1, wherein said housing includes a recess formed in said rear portion thereof, to rotatably receive said first end of said arm.

3. The adjustable earpiece as claimed in claim 1, wherein said first end of said arm includes a ball provided therein, and having said projection extended from said ball, and having said cavity formed in said ball.

4. The adjustable earpiece as claimed in claim 1, wherein said arc includes at least one peripheral groove formed in said first end thereof, and said arm includes at least one peripheral swelling extended therefrom and engaged into said at least one peripheral groove of said arc, to rotatably secure said arm to said arc.

5. The adjustable earpiece as claimed in claim 1, wherein said cover includes at least one orifice formed therein, said housing further includes a circuit board disposed in said housing, and having at least one button disposed thereon and extended through said at least one orifice of said cover.

6. The adjustable earpiece as claimed in claim 1, wherein said housing includes a lock pin extended therefrom, said retainer includes an orifice formed therein to receive said lock pin of said housing, and to position said retainer within said housing.
